(19) United States
(12) Patent Application Publication
(10) Pub. No.: US 2023/0415568 A1
(43) Pub. Date: Dec. 28, 2023

(54) ELECTRIC DRIVEN PTO

(71) Applicant: Amos Power, Inc., Cedar Falls, IA (US)

(72) Inventors: Travis Michael SWEHLA, Alta Vista, IA (US); Zach KOOISTRA, Cedar Falls, IA (US); Henry BOWDEN, Evans, GA (US); Thomas C. BOE, Cedar Falls, IA (US); Daniel Isaiah JOHANNINGMEIER, Cedar Falls, IA (US)

(73) Assignee: Amos Power, Inc., Cedar Falls, IA (US)

(21) Appl. No.: 18/314,304

(22) Filed: May 9, 2023

Related U.S. Application Data
(60) Provisional application No. 63/355,826, filed on Jun. 27, 2022.

(51) Int. Cl. B60K 17/28

(52) U.S. Cl. CPC B60K 17/28; B60Y 2200/221

(57) ABSTRACT

A robotic vehicle with a battery powered power take-off (PTO) shaft. A single battery powers a PTO motor that is directly connected to a torque converter with a PTO shaft output and two independent track motors.

### PRIORITY

This application claims priority to U.S. Provisional Patent Application No. 63/355,826 filed on Jun. 27, 2022 the contents of which are hereby incorporated by reference herein.

### TECHNICAL FIELD

This disclosure relates to autonomous vehicles and, more specifically, to an electric driven power take off (PTO).

### BACKGROUND INFORMATION

There are many instances where autonomous vehicles are preferred to human-operated vehicles. Such autonomous vehicles are particularly advantageous for performing dangerous tasks or operating in hazardous conditions, akin to what first responders or explosive ordinance disposal teams may experience. They are also favorable in situations where large fleets are needed, such as in agriculture, where farms have increased in size but the limited window of time for agricultural operations remains the same. No matter the situation, personnel need autonomous vehicles that are readily available and robust enough to operate in all conditions,

Some large conventionally-powered vehicles, such as trucks, tractors, and even marine craft, use power take-off (PTO) systems to provide power to an attached or separate machine. Typically, the PTO device draws power from the vehicle's combustion engine via a PTO shaft. Common applications for PTO systems include running mowers, threshers and harvesters on agricultural vehicles. Applications for the PTO on vehicles used in other industries are generally known to those in the art.

Therefore, there is a need in the art for a method, system, and/or apparatus that can aid persons in completing various operations. The method, system, and/or apparatus can be used to reduce the time for completing operations, improve the conditions in which an operation can be completed, reduce the amount of manpower needed, or otherwise reduce the number of issues associated with farming and other industries.

### SUMMARY

In accordance with one aspect of the present invention, disclosed is a robotic vehicle comprising: a battery unit; a motor controller electrically connected to the battery unit; a motor connected to the motor controller; a torque converter connected to the motor; and a power take-off (PTO) shaft extending from the gear box. An output of the motor can be positioned coplanar and above the PTO shaft.

In an embodiment, each torque converter further comprises a motor input gear coupled to the output of the motor, an input idler gear coupled to the motor input gear, and a PTO output gear coupled to the input idler gear and coaxially coupled to the PTO shaft. The torque converter can comprise an output idler gear coupled to the PTO output gear and an idler shaft axially coupled to the output idler gear.

Each torque converter can comprise a front plate, a mid-plate, and back plate to locate the motor input gear above the input idler gear and locate the PTO output gear adjacent to the input idler gear and locate the output idler gear above the PTO output gear. A front cover and a rear cover enclose the front plate, the mid-plate and the back plate. The torque converter can comprise a motor input shaft coupled to the output of the motor, wherein the motor input shaft is positioned coplanar above the PTO shaft with the motor extending away from the torque converter rearward of the chassis in a direction of the PTO shaft.

In an embodiment, a coolant system is operably connected to the motor controller and the motor for dissipating heat from the motor controller and the motor. The coolant system comprises of a cooler and a pump for circulating coolant around the controller and the motor and back to the cooler. The cooler can be positioned above the motor. The motor controller can be positioned in the operating unit rearward of the battery unit and positioned above the motor.

### BRIEF DESCRIPTION OF THE DRAWINGS

These and other features and advantages of the present invention will be better understood by reading the following detailed description, taken together with the drawings wherein:

FIG. 1 is a perspective view of a robotic vehicle according to this disclosure.

FIG. 2 is an exploded view of the robotic vehicle of FIG. 1 with the hitch, PTO assembly, and center electronic and cooling assemblies detached from the operating unit.

FIG. 3 is a perspective view of outside of the PTO and center electronic and cooling assemblies.

FIG. 4 is an exploded view of the center electronic and cooling assembly with the side cover panels, rear cooling plenum, coolant pump, motor controller, reservoir, and on-board chargers detached from the operating unit.

FIG. 5 is a perspective view from the left side of the center and PTO cooling system.

FIG. 6 is a perspective view from the right side of the center and PTO cooling system.

FIG. 7 is an exploded view of the gear box.

FIG. 8 is an electrical schematic of the center and PTO cooling system.

FIG. 9 is a cooling schematic of the center and PTO cooling system.

### DETAILED DESCRIPTION OF THE PREFERRED EMBODIMENTS

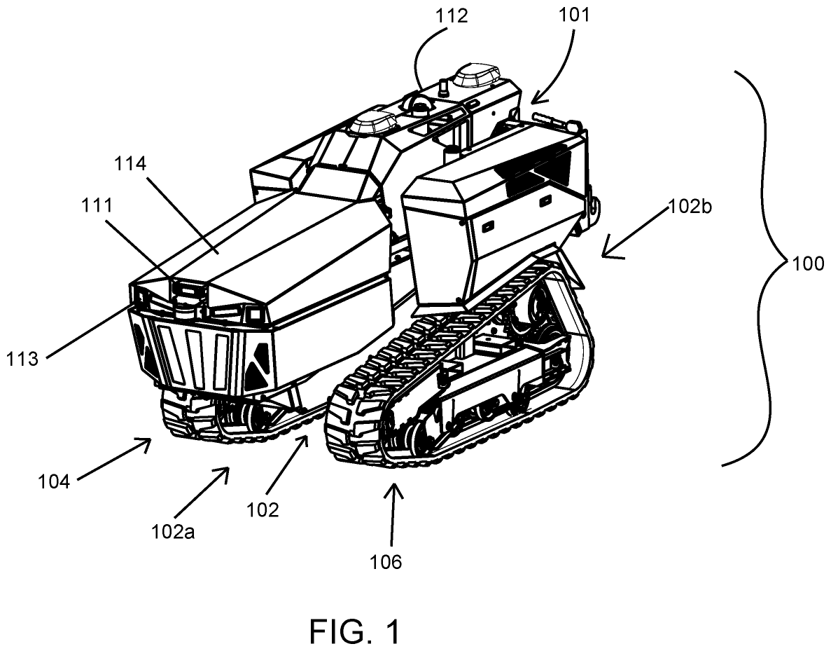

FIG. 1 is a perspective view of a robotic vehicle 100 according to this disclosure. Robotic vehicle 100 is electric driven, and remotely operable, in order to carry out manpower-intensive or high-risk functions without exposing an operator to fatigue or hazard. Robotic vehicle 100 is robust and sturdy to operate in challenging environments. Its low, forward center of gravity allows for towing or hauling equipment many times its weight. With an easily replaceable battery unit 200, robotic vehicle 100 can operate for many hours then quickly exchange battery packs for continued operation.

Robotic vehicle 100 comprises of a central unit 101 with a chassis 102 having a front end 102a and rear end 102b supported on a right track assembly 104 and a left track assembly 106. Each right track assembly 104 and left track assembly 106 has its own motor drive that is removably connectable to an operating unit 112, where the circuitry and software necessary for operating robotic vehicle 100 is located. A front hood 114 projects outward from operating unit 112 of central unit 101 and each motor drive assembly 108 where ancillary equipment such as cameras 111 and lights 113 can be located.

Beneath front hood 114, on chassis 102, and between right track assembly 104, and left track assembly 106, is a battery unit 200. Battery unit 200 may approach 25-30% of the total weight of robotic vehicle 100 weighing more than 1,500 pounds. By positioning battery unit 200 underneath front hood 114 on chassis 102, the center of gravity of robotic vehicle 100 is lowered and moved forward to improve traction and towing capacity. Battery unit 200 and chassis 102 are described more fully in U.S. Pat. No. 11,407,298 filed on Nov. 15, 2021 the contents of which are hereby incorporated by reference herein.

Robotic vehicle 100 comprises right track assembly 104 and left track assembly 106 that are each removably attachable from chassis 102 of central unit 101 of robotic vehicle 100 to make robotic vehicle 100 easily configurable for various applications. Track assembly 104 is described more fully in U.S. Pat. No. 11,364,959 filed on Dec. 27, 2021, the contents of which are hereby incorporated by reference herein.

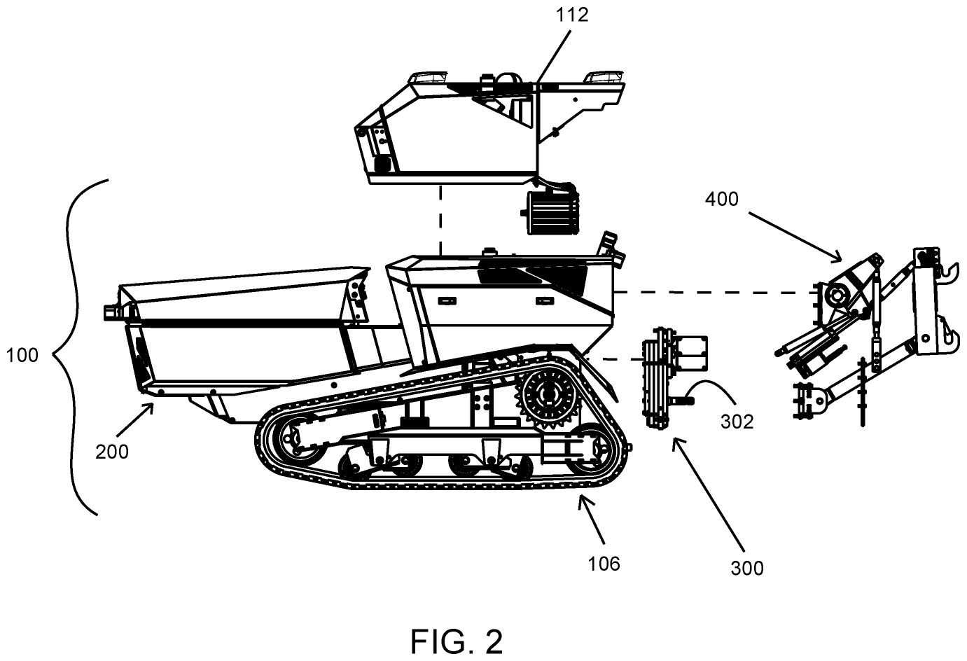

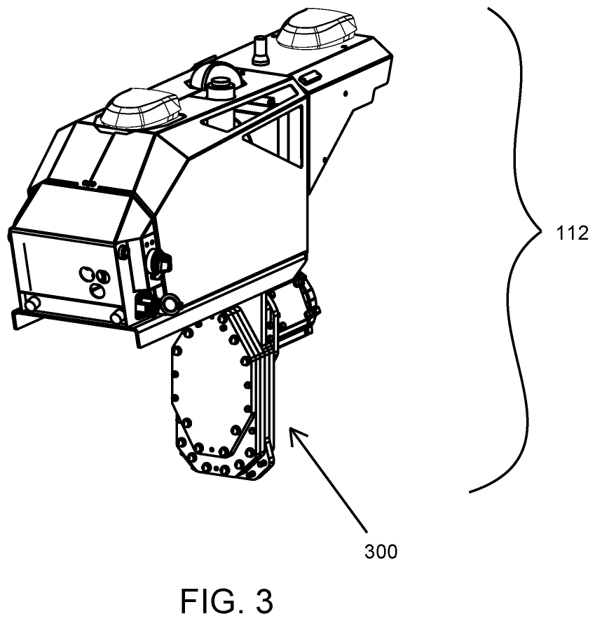

FIG. 2 shows a side view of a robotic vehicle 100 with an electric driven PTO system 300 according to this disclosure and FIG. 3 shows operating unit 112 separate from the other systems of central unit 101 for clarity. Electric driven PTO system 300 is on the back side of operating unit 112 separate from respective right track assembly 104 and left track assembly 106. Electric driven PTO system 300 provides auxiliary power to equipment (such as a hitch 400) by way of one or more PTO shafts 302.

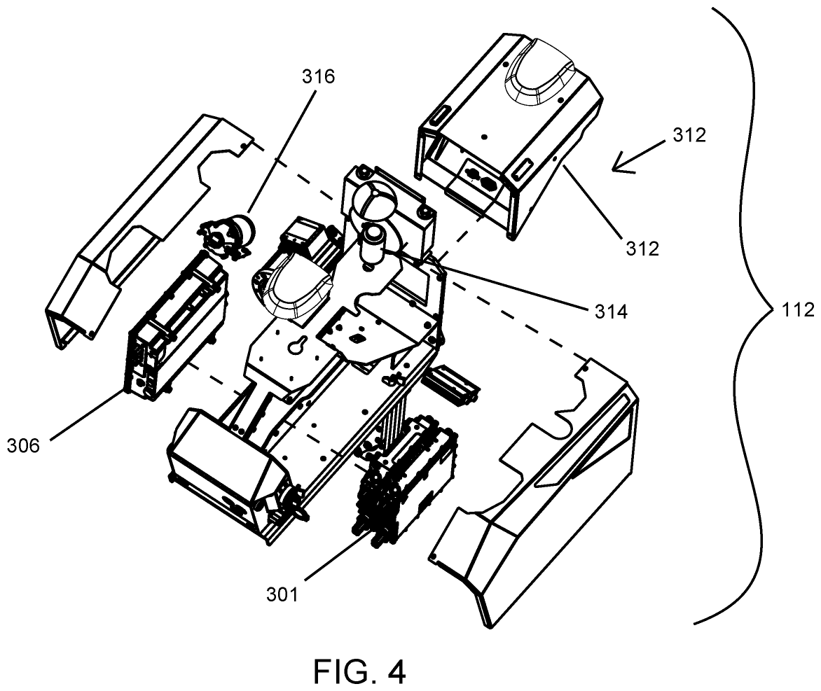

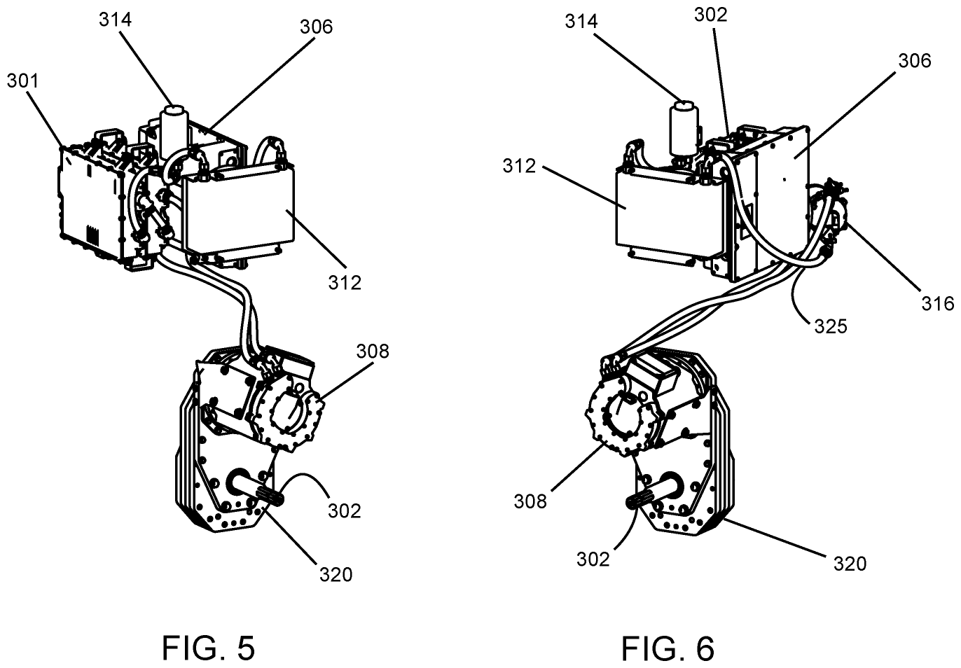

Turning to FIG. 4, shown is electric driven PTO system 300 in more detail. Battery unit 200 (from FIG. 1) is electrically connected to on-board chargers 301 which is electrically connected to a motor controller 306. For a motor 308 (shown in FIG. 5) implemented as an AC motor, motor controller 306 can be implemented as an inverter for converting DC voltage from battery unit 200 to a variable frequency AC power to motor 308. For motor 308 implemented as a DC motor, motor controller 306 can control the rotational speed and torque of motor 308 by regulating the current and voltage applied to motor 308. In this instance, a single battery unit 200 can power both the right and left track assemblies 104, 106 and PTO system 300. Battery unit 200 is also directly connected to PTO system 300, which has motor controller 306 connected directly to motor 308, which means PTO motor 308 operates independent of the traction motors in right and left track assemblies 104, 106.

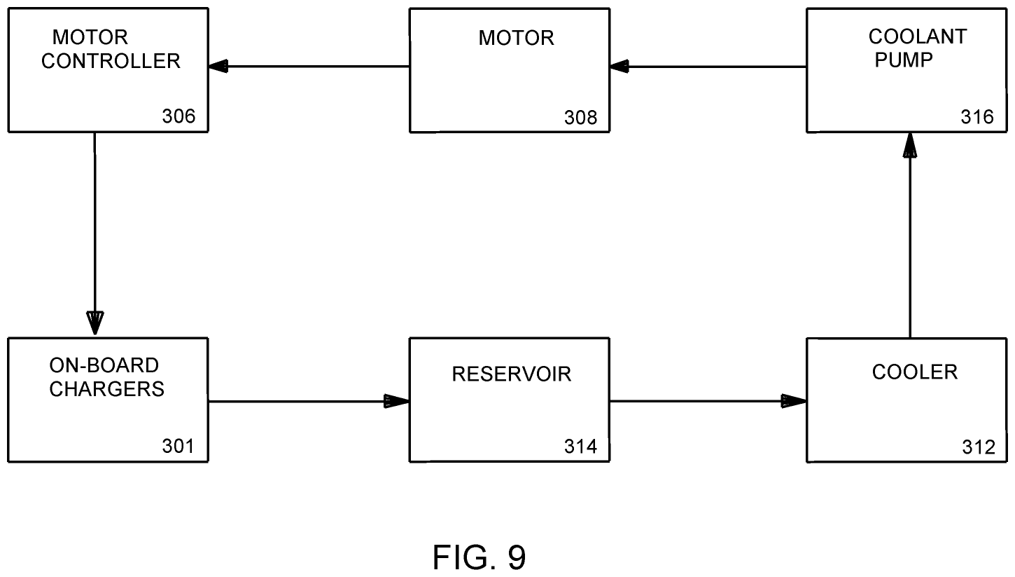

In both instance, on-board chargers 301, motor 308, and motor controller 306 may be cooled to remain in optimal operating conditions. With reference to FIGS. 5-6 and FIG. 9, which shows a high-level schematic for coolant system 310, coolant system 310 comprises of cooler 312 with a built in fan that is in fluid communication with a coolant reservoir 314 and a pump 316. Through a series of hoses 325, pump 316 circulates coolant from coolant reservoir 314 around motor 308, motor controller 306, and on-board chargers 301 to cooler 312 where excess heat can be dissipated. It will be noticed that cooler 312 with its built in fan is uniquely positioned near the rear of robotic vehicle 100.

Turning to FIG. 5 and FIG. 6, a PTO torque converter 320 is provided to position motor 308 with respect to PTO shaft 302. In the illustrated embodiment, the output of motor 308 is co-planar with PTO shaft 302 but faced axially in the opposite direction. Internal gears in PTO torque converter 320 connect the output of motor 308 to PTO shaft 302.

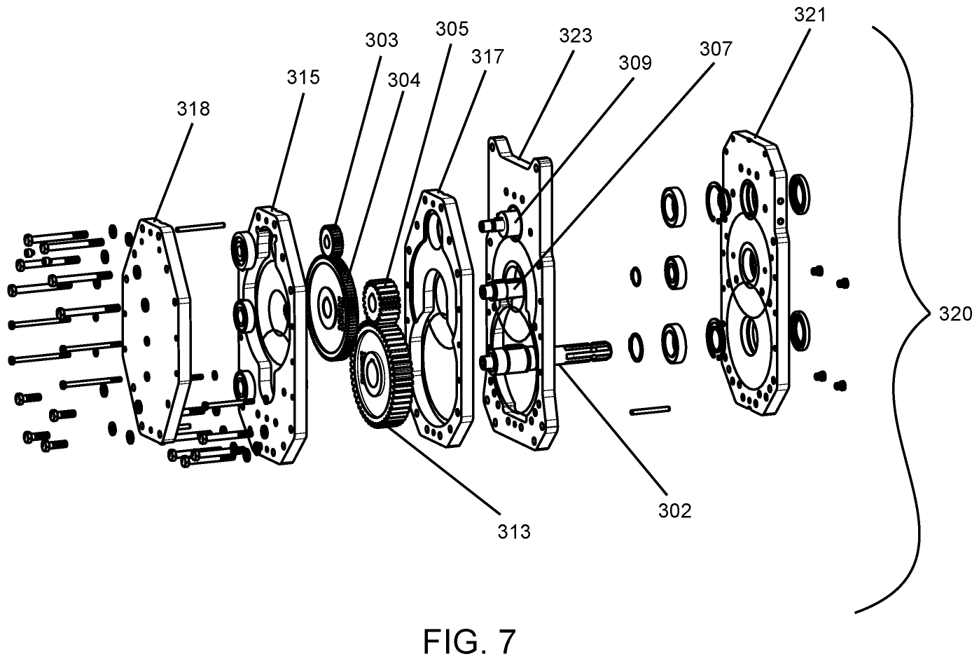

Torque converter 320 is best illustrated in FIGS. 5-6, which shows a front-side perspective view of torque converter 320 and FIG. 7 which shows an exploded view of torque converter 320 defined by the dimensions between front cover 318 and rear cover 321. Beginning with FIG. 7, the output shaft of motor 308 is coupled to torque converter 320 through a motor input shaft 309. Motor input shaft 309 is axially coupled to a motor input gear 303, which is engaged to an input idler gear 304. Idler gear 304 is axially coupled to idler shaft 307 which is also axially coupled to an output idler gear 305. Output idler gear 305 is engaged with a PTO output gear 313, which is axially coupled to PTO shaft 302.

The foregoing gears are located in a front plate 315, a mid-plate 317, and a back plate 323, which is all sealed together between a front cover 318 and a rear cover 321.

All of the foregoing components are mechanically connected together in an innovative arrangement with motor 308 being vertically elevated above PTO shaft 302 and with an axis of rotation of an output of motor 308 being above the axis of rotation of PTO shaft 302 to keep it elevated high enough from the ground to keep dust and debris away. The mechanical equipment connecting these components together are all isolated inside a narrow, five-inch thick, torque converter 320.

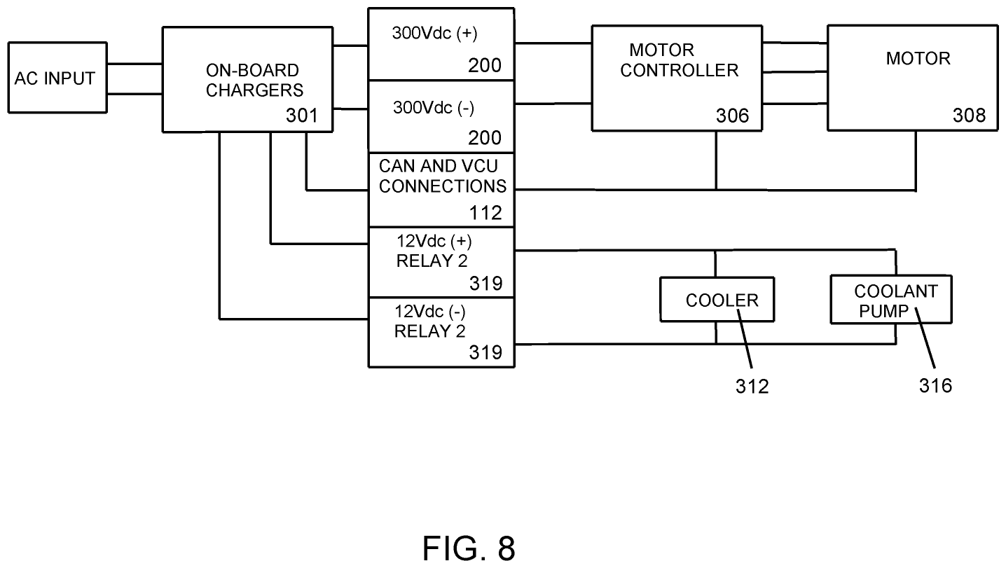

FIG. 8 is a high-level electrical schematic for the electric driven PTO of FIGS. 5-6. Central unit 101 of robotic vehicle 100 comprises of battery unit 200 that is electrically connected to operating unit 112, which contains the software and hardware necessary to drive and control robotic vehicle 100. Battery unit 200 is also connected to motor controller 306. Power from battery unit 200 and bi-directional control and response signals from operating unit 112 are therefore supplied directly to motor controller 306. Battery unit 200 also supplies through low voltage DC relays 319 power to cooler 312 and pump 316.

The foregoing described electric driven PTO system 300 is comprised in robotic vehicle 100 and comprises of a coolant system 310 operably connected to motor controller 306 and motor 308 for dissipating heat from motor controller 306 and motor 308. Coolant system 310 can comprise of a cooler 312 and a pump 316 for circulating coolant around motor controller 306 and motor 308 to cooler 312. In an embodiment, motor controller 306 is positioned forward of cooler 312 with respect to the front of robotic vehicle 100 and positioned above PTO torque converter 320, including motor 308. In this regard, coolant system 310 and motor controller 306 are positioned with operating unit 112 separate from right track assembly 104 and left track assembly 106. PTO torque converter positions output of motor 308 coplanar with PTO shaft 302 in axially opposite direction.

Those skilled in the art will understand that the illustrated embodiments described above are exemplary. Other changes and modifications to robotic vehicle 100 are contemplated herein. In an alternative implementation, a single motor controller 192 can be positioned in central unit 101 and configured to power motor 154 for left track assembly 106 and right track assembly 104. Similarly, a single coolant system 190 can be positioned in central unit 101 with additional quick release connections of hoses 199. Such modifications provide the modular benefits of the illustrated embodiments, but are presently believed to be dis-advantageous due to the lack of availability or costs of a single motor controller 192 to drive multiple motors 154.

Terms used herein are presumed to have their ordinary meaning to those skilled in the art unless a different meaning is given. Substantially, as used herein, is defined to have a standard dictionary definition of being largely but not wholly that which is specified.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

We claim:

1. A robotic vehicle comprising:
a battery unit;
a motor controller electrically connected to the battery unit;
a motor connected to the motor controller;
a torque converter connected to the motor; and
a power take-off (PTO) shaft extending from the gear box.

2. The robotic vehicle of claim 1, and further comprising wherein an output of the motor is positioned coplanar and above the PTO shaft.

3. The robotic vehicle of claim 2, wherein each torque converter further comprises a motor input gear coupled to the output of the motor, an input idler gear coupled to the motor input gear, and a PTO output gear coupled to the input idler gear and coaxially coupled to the PTO shaft.

4. The robotic vehicle of claim 3, wherein the torque converter further comprises an output idler gear coupled to the PTO output gear and an idler shaft axially coupled to the output idler gear.

5. The robotic vehicle of claim 4, wherein each torque converter further comprises a front plate, a mid-plate, and back plate to locate the motor input gear above the input idler gear and locate the PTO output gear adjacent to the input idler gear and locate the output idler gear above the PTO output gear.

6. The robotic vehicle of claim 5, wherein the torque converter further comprises a front cover and a rear cover to enclose the front plate, the mid-plate and the back plate.

7. The robotic vehicle of claim 1, and further comprising a coolant system operably connected to the motor controller and the motor for dissipating heat from the motor controller and the motor.

8. The robotic vehicle of claim 7, wherein the coolant system comprises of a cooler and a pump for circulating coolant around the controller and the motor and back to the cooler.

9. The robotic vehicle of claim 8, wherein the cooler is positioned above the motor.

10. A robotic vehicle, comprising:
a chassis comprising a right side and a left side;
an operating unit positioned rearward on the chassis;
a battery unit positioned forward on the chassis;
a PTO motor controller electrically connected to the battery unit;
a PTO motor connected to the PTO motor controller;
a torque converter connected to the PTO motor;
a PTO shaft extending from the gear box;
a coolant system operably connected to the PTO motor controller and the PTO motor for dissipating heat from the PTO motor controller and the PTO motor;
a right track assembly separable from the right side of the chassis; and
a left track assembly separable from the left side of the chassis, wherein each of the right track assembly and the left track assembly comprise a track motor operably connected to a track.

11. The robotic vehicle of claim 10, wherein the coolant system comprises of a cooler and a pump for circulating coolant around the PTO motor controller and the PTO motor and back to the cooler.

12. The robotic vehicle of claim 11, wherein the PTO motor is positioned above the right track assembly and the left track assembly to position the PTO motor a sufficient distance above the ground.

13. The robotic vehicle of claim 12, and further comprising wherein an output of the PTO motor is positioned coplanar and above the PTO shaft.

14. The robotic vehicle of claim 13, wherein each torque converter further comprises a motor input gear coupled to the output of the PTO motor, an input idler gear coupled to the motor input gear, and a PTO output gear coupled to the input idler gear and coaxially coupled to the PTO shaft. The robotic vehicle of claim 14, wherein the torque converter further comprises an output idler gear coupled to the PTO output gear and an idler shaft axially coupled to the output idler gear.

16. The robotic vehicle of claim 15, wherein each torque converter further comprises a front plate, a mid-plate, and back plate to locate the motor input gear above the input idler gear and locate the PTO output gear adjacent to the input idler gear and locate the output idler gear above the PTO output gear.

17. The robotic vehicle of claim 16, wherein the torque converter further comprises a front cover and a rear cover to enclose the front plate, the mid-plate and the back plate.

18. The robotic vehicle of claim 10, wherein the PTO motor controller is positioned in the operating unit rearward of the battery unit and positioned above the PTO motor.

19. The robotic vehicle of claim 14, wherein the torque converter further comprises a motor input shaft coupled to the output of the PTO motor wherein the motor input shaft is positioned coplanar above the PTO shaft with the PTO motor extending away from the torque converter rearward of the chassis in a direction of the PTO shaft. The robotic vehicle of claim 14, wherein a single battery unit powers the PTO motor and the track motor for each right track assembly and left track assembly, and wherein the PTO motor operates independent of the track motor for each right track assembly and left track assembly.
